(19) United States
(12) Patent Application Publication
(10) Pub. No.: US 2023/0192562 A1
(43) Pub. Date: Jun. 22, 2023

(54) POLYMER YARNS FOR FABRIC STABILITY AND UNIFORMITY, PLIES MANUFACTURED THEREFROM AND ARTICLES COMPRISING THE SAME

(71) Applicant: Raytheon Technologies Corporation, Farmington, CT (US)

(72) Inventors: Kathryn S. Read, Marlborough, CT (US); Bryan H. Farrar, West Hartford, CT (US); Andrew J. Lazur, La Jolla, CA (US); Steven R. Clarke, Mansfield, MA (US); Aaron Tomich, Sutton, MA (US)

(21) Appl. No.: 18/083,983

(22) Filed: Dec. 19, 2022

Related U.S. Application Data
(60) Provisional application No. 63/291,841, filed on Dec. 20, 2021.

(51) Int. Cl. C04B 35/80; D03D 15/283; D03D 15/242

(52) U.S. Cl. CPC C04B 35/80; D03D 15/283; D03D 15/242; C04B 2235/5216; C04B 2235/616; C04B 2235/5212; D10B 2321/06; D10B 2321/08; D10B 2505/02

(57) ABSTRACT

Disclosed herein is a composite ply comprising fill and warp tows; or optional axial and bias tows; wherein one or more of the fill tows and/or the warp tows or wherein one or more of the optional axial and/or bias tows comprise a polymer yarn while the remaining portion of the fill tows and/or the warp tows or the remaining portion of the bias and/or optional axial tows comprise the polymer yarn; and wherein the polymer yarn is melted to bond to the fill or warp tows to prevent removal from the ply.

### CROSS-REFERENCE TO RELATED APPLICATIONS

This application claims the benefit of U.S. Provisional Application Ser. No. 63/291,841 filed Dec. 20, 2021, which is incorporated herein by reference in its entirety.

### BACKGROUND

This disclosure relates to polymer yarns for fabric stability, plies manufactured therefrom and articles that comprise the same.

Preforms are used for the fabrication of ceramic matrix composite (CMC) structures using chemical vapor infiltration (CVI), polymer infiltration pyrolysis (PIP) and melt infiltration (MI). A preform generally comprises a plurality of plies which are made from a fabric. The fabric comprises fibers, which can be unidirectional or woven (e.g., plain weave, 5 Harness Satin Weave, 8 Harness Satin Weave, twill). These fibers are often manufactured from ceramics.

Chemical vapor infiltration (CVI) is a process whereby matrix material is infiltrated into fibrous preforms by the use of reactive gases at elevated temperature to form fiber-reinforced composites. CVI can be applied to the production of ceramic-matrix composites. CMCs can potentially be used at temperatures of up to and greater than 2700° F. Polymer infiltration pyrolysis (PIP) comprises the infiltration of a low viscosity polymer into the fiber structure, followed by pyrolysis. Under pyrolysis, the polymer precursor is heated in an inert atmosphere and transformed into a ceramic due to its decomposition. Melt infiltration is based on the infiltration of porous matrices with the melt of an active phase or precursor.

As noted above, the preform is manufactured from a fabric that comprises ceramic tows. To achieve a preform that will enable the desired ceramic matrix composite material properties, it may be necessary to use woven or braided architectures that are prone to distortions and loss of tows. This makes fabricating small complex geometry plies and preforms difficult.

The loss of tows creates an irregular microstructure which upon being filled by the ceramic matrix creates reduced matrix driven properties. The loss of tows also locally impacts the in-plane performance of the resulting composite. To accommodate for this, plies are frequently cut oversized which leads to the use of expensive machining processes following the completion of matrix densification.

It is therefore desirable to create plies and preforms that are devoid of the aforementioned defects that results in the loss of tows. This would improve handleability and uniformity of tow distribution of these fabrics.

### BRIEF DESCRIPTION

A composite ply comprises a woven ply or a braided ply and a polymeric yarn. The woven tow comprises ceramic fill and warp tows while the braided ply comprises ceramic bias and optional axial tows. The polymer yarn is disposed in the a) the fill tows, warp tows, or both the fill and warp tows or b) the bias tows, the optional axial tows, or both the bias and optional axial tows; or the polymer yarn is substituted for a) a portion of fill tows, warp tows, or both the fill and warp tows; or b) a portion of bias tows, optional axial tows or a combination of bias and optional axial tows; or the polymer yarn is disposed in the form of a ribbon or a net on a) a portion of fill tows, warp tows, or both the fill and warp tows; or b) a portion of bias tows, optional axial tows or a combination of bias and optional axial tows. The polymer yarn bonds with the fill or warp tows or bonds with the bias or optional axial tows to prevent tow displacement in the composite ply.

In an embodiment, the polymer yarn is woven into the fill tows, warp tows, or both the fill and warp tows after the fill and warp tows are first woven into a ply or the polymer yarn is woven into the optional axial tows, bias tows, or both the optional axial and bias tows after the optional axial and bias tows are first braided into a braid.

In another embodiment, the polymer yarn is heated above its glass transition temperature or is heated above its melting point to soften and bond it with the fill or warp tows or bond it with the bias or optional axial tows.

In yet another embodiment, the polymer yarn is operative to bind adjacent plies with the composite ply in a lay-up.

In yet another embodiment, the polymer yarn comprises a thermoplastic polymer, a thermosetting polymer, or a combination thereof.

In yet another embodiment, the polymer yarn comprises a water-soluble polymer.

In yet another embodiment, the water-soluble polymer is a polyvinylalcohol, a polyacrylamide, or a combination thereof.

In yet another embodiment, the polymer yarn contacts at least two adjacent fill or warp tows in the composite ply.

In another embodiment, the fill or warp tows comprise silicon carbide (SiC), alumina (Al₂O₃), mullite (Al₂O₃—SiO₂), or a combination thereof.

In yet another embodiment, the composite ply is incorporated into a preform.

In yet another embodiment, the preform that contains the composite ply is subjected to chemical vapor infiltration, polymer infiltration, melt infiltration, or a combination thereof with a ceramic matrix precursor to form a matrix material in the preform.

In yet another embodiment, the matrix material comprises SiC, Al₂O₃, BN, B₄C, Si₃N₄, MoSi₂, SiO₂, SiOC, SiNC, and/or SiONC.

In yet another embodiment, the fill tows or the warp tows that the polymer yarn is substituted for are periodically spaced or wherein the bias tows or optional axial tows that the polymer yarn is substituted for is periodically spaced.

In yet another embodiment, the fill tows or the warp tows that the polymer yarn is substituted for are randomly spaced or wherein the bias tows or optional axial tows that the polymer yarn is substituted for are randomly spaced.

In yet another embodiment, the composite ply displays better edge retention of tows during cutting over a similar ply that does not contain the polymer yarn.

In yet another embodiment, the composite ply displays less rotating or twisting distortion of the fill and warp tows or the bias and optional axial tows as compared with a similar ply that does not contain the polymer yarn, when both plies are subjected to equivalent deformation.

In yet another embodiment, all of the fill tows or all of the warp tows comprise the polymer yarn or wherein all of the optional axial or the bias tows comprise the polymer yarn.

In an embodiment, an article manufactured from the composite ply of Claim 1.

A method of manufacturing a composite ply comprises a) disposing a polymer yarn into a woven ply that comprises fill tows and warp tows to form the composite ply; or disposing a polymer yarn into a braided ply that comprises ceramic bias tows and optional axial warp tows to form the composite ply; or b) substituting a polymer yarn for a portion of fill tows, warp tows, or both the fill and warp tows in a woven ply to form the composite ply; or substituting a portion of bias tows, optional axial tows or a combination of bias and optional axial tows in a braided ply to form the composite ply; or c) disposing a polymer yarn in the form of a ribbon or a net on a portion of fill tows, warp tows, or both the fill and warp tows to form the composite ply; or disposing a polymer yarn in the form of a ribbon or a net on a portion of bias tows, optional axial tows or a combination of bias and optional axial tows to form the composite ply; and softening the polymer yarn to bond to the fill or warp tows or to bond to the bias tows and optional axial tows to prevent their displacement from the composite ply.

In an embodiment, the composite ply is further subjected to a chemical vapor infiltration process, a polymer infiltration pyrolysis, melt infiltration, or a combination thereof, where a ceramic matrix precursor infiltrates the ply.

In yet another embodiment, the polymer yarn is decomposed.

In yet another embodiment, the polymer yarn comprises a water soluble polymer.

### BRIEF DESCRIPTION OF THE DRAWINGS

The following descriptions should not be considered limiting in any way. With reference to the accompanying drawings, like elements are numbered alike:

FIG. 1 depicts a woven composite ply that comprises a weaving pattern in which the warp tows and weft or fill tows alternate and in which the polymer yarn is disposed in the warp tows;

FIG. 2 depicts a composite ply where the polymer yarn is substituted in a regular pattern for an alternating set of tows (either bias tows or optional axial tows or both) in a braided ply;

FIG. 3 depicts a composite ply where the polymer yarn in the form of a net is disposed on a braided ply; and

FIG. 4 depicts a 3-D ply where a polymer traverses the ply in the z-direction.

### DETAILED DESCRIPTION

A detailed description of one or more embodiments of the disclosed apparatus and method are presented herein by way of exemplification and not limitation with reference to the Figures.

Disclosed herein is a polymeric yarn that is woven or braided into a composite ply to prevent the loss ceramic tows from the architecture during a cutting and/or preforming process by locking them in place during processing. The composite ply may be a traditional 2D weave cloth or braided layer into which the polymer yarn is woven or braided or upon which it is disposed. Alternatively, the composite ply may be a traditional 2D weave or braid. In an embodiment, the polymer yarn is softened either during or after being disposed upon the perform thus bonding itself to the ceramic tows and preventing the loss of tows from the woven or braided material during subsequent processing. The softening occurs by heating the polymeric yarn above its softening point (glass transition temperature or crystalline temperature) or by contacting it with a solvent. The solvent plasticizes the polymer thus softening it.

In an embodiment, the polymer yarn is heated slightly during the process for it to melt and tack the tows in place, or alternatively, contacted with a solvent to soften it enough to tack the tows in place. The polymer yarn is referred to as a hot melt yarn and is paired with the tows and woven into the structure to form the composite ply. In a woven composite ply, the polymer yarn may be used in either the warp tows, fill tows, or both. In a braided composite ply, the polymer yarn may be used in the bias tows, the optional axial tows or both.

The polymer yarn may be served on the fiber or just paired with the tow. Since these yarns are locked in position by heat or by the solvent, they will lock the ceramic fibers together in the desired state until they are removed either by the application of heat or by applying a suitable solvent. This enables the woven material to have better edge retention during cutting and experience less undesirable distortion when plies are applied in the formation of a complex shape. The polymer yarn can also serve as a binder to join adjacent plies in a lay-up.

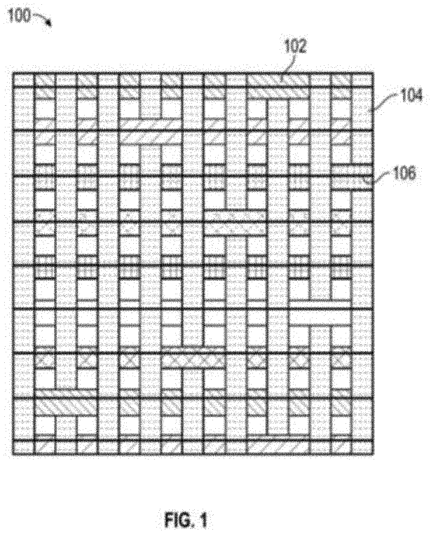

FIG. 1 depicts a woven composite ply 100 that comprises warp tows 102 and weft or fill tows 104 that are woven together and in which the polymer yarn 106 is woven into the warp fibers. The polymer yarn 106 may also be woven into the fill tows (not shown) or both the fill and the warp tows (not shown). When the composite ply 100 is braided and comprises axial and bias tows, the polymer yarn 106 may be woven into the axial tows, the bias tows, or both the axial and the bias tows (not shown). In an alternative embodiment, the polymer yarn is woven into the fill tows, warp tows, or both the fill and warp tows after the fill and warp tows are first woven into a ply. Similarly, the polymer yarn is woven into the axial tows, bias tows, or both the axial and bias tows after the axial and bias tows are first braided into a braid. In an embodiment, the axial tows are optional in the braided composite plies. These axial tows may or may not be present in the braided composite ply. While the axial tows are not always described as being optional, they should be always considered as being such (i.e., optional) in all of the braided composite plies.

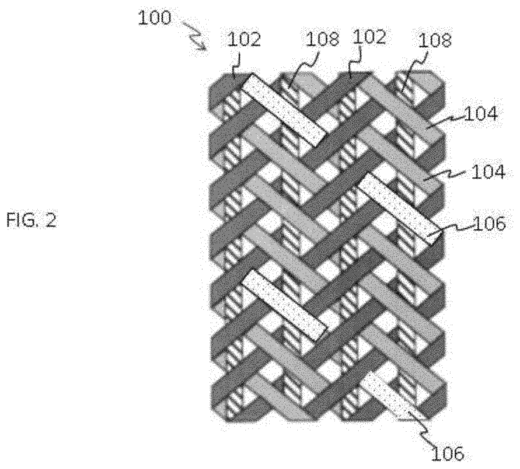

In another embodiment directed to a braided composite ply 100 depicted in the FIG. 2, the polymer yarn 106 is substituted in a regular braiding pattern for one set of bias tows 102, 104, and so on . . . and/or axial tows 108 in a ply. FIG. 2 depicts a plurality of bias tows 102 and 104 along with axial tows 108. As noted above, these axial tows may be optional. A portion of the ceramic bias tows are replaced by a polymer yarn 106. In an embodiment, the polymer yarn 106 is substituted for some or all of the bias tows in the ply. For example, the polymer yarn 106 is used to substitute every second bias tow, every third bias tow or every fourth bias tow 104, and so on. In the FIG. 2, the polymer yarn 106 is used to replace every fourth ceramic tow in one particular direction.

In an embodiment (not shown), the polymer yarn may also be substituted for a portion or all of the warp tows, the fill tows or both the fill and the warp tows of a woven ply to form the woven composite ply.

While the polymer yarns 106 are periodically spaced (as seen in the FIG. 2), they may also be randomly spaced. Alternately, the polymer yarns could replace all bias tows in a woven architecture to form a ply with unidirectional reinforcement. In a preferred embodiment, the polymer yarn is woven onto either the bias tows or the warp tows to form the composite ply.

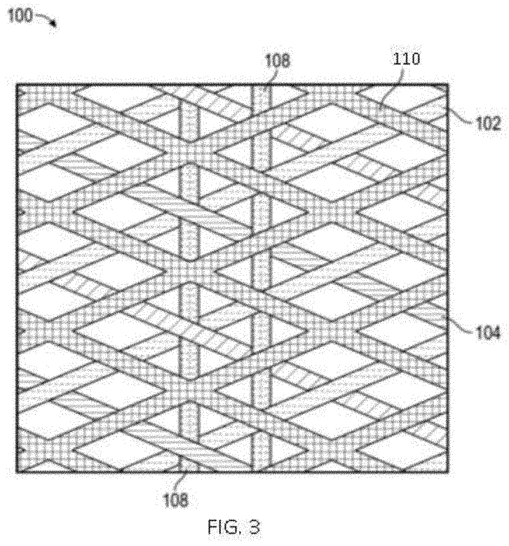

FIG. 3 depicts yet another embodiment in which a polymer net 110 is disposed atop a braided composite ply 100. The polymer net 110 may be manufactured from a thermoplastic resin or from a resin that can be crosslinked upon the application of an initiating stimulus (e.g., heat, initiator, electromagnetic radiation, and the like). FIG. 3 depicts a braided composite ply 100 that comprises a plurality of bias tows 102 and 104 along with axial tows 108. A polymer net 110 having its respective fibers oriented in the same direction as the bias tows 102 and 104 of the braided composite ply 100 is disposed atop the ply. While the polymer net 110 is oriented in the direction of the bias tows in the FIG. 3, they can alternatively be disposed along any other desired direction. While the FIG. 3 depicts a polymer net 110 as being disposed atop the braided composite ply 100, it is possible to instead dispose ribbons of polymer from a device such as, for example, a glue gun atop the braided composite ply 100. The ribbons may be disposed along the direction of the axial or bias tows or in a random direction if desired. The net may also be placed on a woven ply (not shown) if desired. The net is then melted into the ply to holds the tows in place (i.e., it prevents the tows from being displaced).

In a preferred embodiment, the polymer net is distributed onto either the bias tows or the warp tows to form the composite ply.

The ply 100 with the polymer yarn 106 present therein (see FIGS. 1 and 2) or with the polymer net 110 disposed thereon (see FIG. 3) is heated slightly during the weaving process thereby causing the polymer yarn to melt which bonds (also called “tacks”) the tows in place. In another embodiment, the ply 100 with the polymer yarn 106 woven therein is subjected to a spray of a solvent that can plasticize the polymer. The solvent is compatible with the polymer yarn and is added in a quantity effective to not completely dissolve the polymer. The polymer yarn is therefore softened by the solvent and tacks the tows in place. In an embodiment, a combination of heat and a solvent may be used to soften the polymer to tack the tows in place.

In another embodiment, the disposing of the polymer yarn 106 on the fill tows or the warp tows (of the woven ply) (or the axial or bias tows of the braided ply) may be conducted during or after the weaving of the plies.

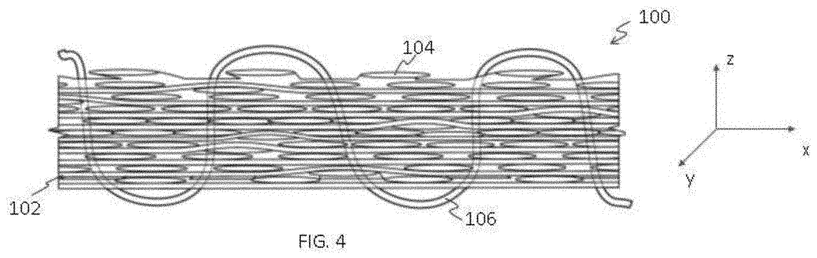

In yet another embodiment, the polymer yarn 106 may be woven through a 2-D ply (or preform) or through a 3-D ply (or preform). FIG. 4 depicts the use of a polymer yarn 106 that is woven through a 3-D preform 100 comprising warp tows 102 and fill tows 104. The polymer yarn 106 is woven through the thickness of the plurality of plies that form the 3-D preform. The polymer yarn 106 may be softened via heat, solvent or a combination of heat and solvent to tack the tows in place. While the FIG. 4 depicts one polymer yarn through the thickness of the 3-D preform 100 (In the z-direction), a plurality of polymer yarns may be used to tack the tows. Some of these yarns may traverse the 3-D preform in the y-direction, the x-direction, or in some intermediate direction that combines the x-direction, the y-direction and the z-direction. In yet another embodiment, the polymer yarn 106 may be woven through a 2-D ply (or preform) or through a 3-D ply (or preform) forming a composite ply. FIG. 4 depicts the use of a polymer yarn 106 that is woven through a 3-D preform 100 comprising warp tows 102 and fill tows 104. The polymer yarn 106 is woven through the thickness of the plurality of plies that form the 3-D preform. The polymer yarn 106 may be softened via heat, solvent or a combination of heat and solvent to tack the tows in place. While the FIG. 4 depicts one polymer yarn through the thickness of the 3-D preform 100 (e.g., in the z-direction), a plurality of polymer yarns may be used to tack the tows. Some of these yarns may traverse the 3-D preform in the y-direction, the x-direction, or in some intermediate direction that combines the x-direction, the y-direction and the z-direction.

In an embodiment, the woven or braided composite ply 100 of the FIG. 1, 2, 3 or 4 is transported into a heated zone to cause partial melting and flow of the polymer yarn to secure the tows (that are in contact with the molten polymer yarn 106) in place. The polymer yarn 106 may be heated to above its glass transition temperature (if it is an amorphous polymer) or above its melting point (if it is a semi-crystalline polymer). The polymer yarn 106 is heated so as to flow slightly thereby increasing its ability to adhesively bond to the tows and secure them in position.

The heating may be facilitated by conduction, convection, radiation or a combination thereof. In a preferred embodiment, the heating is facilitated using convection, radiation, or a combination thereof.

In another embodiment, a suitable solvent may be applied to the polymer yarn 106 to solubilize the polymer (in the yarn), which promotes adhesive contact between the polymer and the tows thus securing the tows. This could be used instead of or in addition to heating.

The solvent is one that preferably solubilizes the polymer or partially solubilizes the polymer used in the yarn. Suitable co-solvents may also be used depending upon their solubilization capability.

Liquid aprotic polar solvents such as water, propylene carbonate, ethylene carbonate, butyrolactone, acetonitrile, benzonitrile, nitromethane, nitrobenzene, sulfolane, dimethylformamide, N-methylpyrrolidone, or the like, or a combination thereof may be used to solubilize the polymer. Polar protic solvents such as, but not limited to, water, methanol, acetonitrile, nitromethane, ethanol, propanol, isopropanol, butanol, or the like, or a combination thereof may be used to solvate the polymer. Other non-polar solvents such a benzene, toluene, methylene chloride, carbon tetrachloride, hexane, diethyl ether, tetrahydrofuran, or the like, or a combination thereof may also be used. Co-solvents comprising at least one aprotic polar solvent and at least one non-polar solvent may also be utilized to modify the swelling power of the solvent and thereby adjust the rate of dissolution of the polymer.

The partial melting and flow of the polymer yarn to secure the tows (that in contact with the molten polymer yarn 106) in place may be conducted in roll mills. The polymer yarn after melting and/or solubilization contacts at least two adjacent fill and/or warp tows in the composite ply. In an embodiment, the polymer yarn after melting and/or solubilization contacts at least three adjacent fill and/or warp tows in the composite ply.

After securing the tows in place, the ply may be combined with other plies to manufacture a preform (not shown). The preform is then placed in chemical vapor infiltration chamber to infiltrate the preform with vapors. The vapors infiltrate into the preform plies (undergoing a reaction) to form a matrix. During or prior to the vapor infiltration process, the polymer decomposes from the preform.

Suitable ceramic tows (for the fill and warp tows) comprise silicon carbide (SiC), alumina (Al₂O₃), mullite (Al₂O₃—SiO₂), or a combination thereof. In an embodiment, the tow may contain non-ceramic fibers. Suitable non-ceramic fibers are carbon fibers. The ceramic matrix (that fills in the space between the fibers) comprises SiC, Al₂O₃, BN, B₄C, Si₃N₄, MoSi₂, SiO₂, SiOC, SiNC, and/or SiONC.

The polymer yarn comprises an organic polymer that may be amorphous or semi-crystalline. Organic polymers used in the polymer yarns can be from a wide variety of thermoplastic polymers, blend of thermoplastic polymers, thermosetting polymers, or blends of thermoplastic polymers with thermosetting polymers. The organic polymer may also be a blend of polymers, copolymers, terpolymers, or combinations comprising at least one of the foregoing organic polymers. The organic polymer can also be an oligomer, a homopolymer, a copolymer, a block copolymer, an alternating block copolymer, a random polymer, a random copolymer, a random block copolymer, a graft copolymer, a star block copolymer, a dendrimer, a polyelectrolyte (polymers that have some repeat groups that contain electrolytes), a polyampholyte (a polyelectrolyte having both cationic and anionic repeat groups), an ionomer, or the like, or a combination comprising at last one of the foregoing organic polymers. The organic polymers have number average molecular weights greater than 10,000 grams per mole, preferably greater than 20,000 g/mole and more preferably greater than 50,000 g/mole.

Examples of thermoplastic polymers that can be used in the polymeric yarn include polyacetals, polyacrylics, polycarbonates, polyalkyds, polystyrenes, polyolefins, polyesters, poly amides, polyaramides, polyamideimides, polyarylates, polyurethanes, epoxies, phenolics, silicones, polyarylsulfones, polyethersulfones, polyphenylene sulfides, polysulfones, polyimides, polyetherimides, polytetrafluoroethylenes, polyetherketones, polyether ether ketones, polyether ketone ketones, polybenzoxazoles, polyoxadiazoles, polybenzothiazinophenothiazines, polybenzothiazoles, polypyrazinoquinoxalines, polypyromellitimides, polyguinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, polypropylenes, polyethylenes, polyethylene terephthalates, polyvinylidene fluorides, polysiloxanes, or the like, or a combination thereof.

Examples of polyelectrolytes are polystyrene sulfonic acid, polyacrylic acid, pectin, carrageenan, alginates, carboxymethylcellulose, polyvinylpyrrolidone, or the like, or a combination thereof.

Examples of thermosetting polymers suitable for use as hosts in emissive layer include epoxy polymers, unsaturated polyester polymers, polyimide polymers, bismaleimide polymers, bismaleimide triazine polymers, cyanate ester polymers, vinyl polymers, benzoxazine polymers, benzocyclobutene polymers, acrylics, alkyds, phenol-formaldehyde polymers, novolacs, resoles, melamine-formaldehyde polymers, urea-formaldehyde polymers, hydroxymethylfurans, isocyanates, diallyl phthalate, triallyl cyanurate, triallyl isocyanurate, unsaturated polyesterimides, or the like, or a combination thereof.

Examples of blends of thermoplastic polymers include acrylonitrile-butadiene-styrene/nylon, polycarbonate/acrylonitrile-butadiene-styrene, acrylonitrile butadiene styrene/polyvinyl chloride, polyphenylene ether/polystyrene, polyphenylene ether/nylon, polysulfone/acrylonitrile-butadiene-styrene, polycarbonate/thermoplastic urethane, polycarbonate/polyethylene terephthalate, polycarbonate/polybutylene terephthalate, thermoplastic elastomer alloys, nylon/elastomers, polyester/elastomers, polyethylene terephthalate/polybutylene terephthalate, acetal/elastomer, styrene-maleicanhydride/acrylonitrile-butadiene-styrene, polyether etherketone/polyethersulfone, polyether etherketone/polyetherimide polyethylene/nylon, polyethylene/polyacetal, or the like, or a combination thereof.

The polymer yarns can also include biodegradable materials. Suitable examples of biodegradable polymers are as polylactic-glycolic acid (PLGA), poly-caprolactone (PCL), copolymers of polylactic-glycolic acid and poly-caprolactone (PCL-PLGA copolymer), polyhydroxy-butyrate-valerate (PHBV), poly orthoester (POE), polyethylene oxide-butylene terephthalate (PEO-PBTP), poly-D,L-lactic acid-p-dioxanone-polyethylene glycol block copolymer (PLA-DX-PEG), or the like, or a combination thereof.

Exemplary polymers for use in the yarns are water soluble polymers. An exemplary polymer for use in the yarn is polyvinylalcohol, polyacrylamide, or a combination thereof. The polymer is preferably a low char polymer. A low char polymer leaves behind little or no residue upon undergoing decomposition (when subjected to temperatures above the decomposition temperature).

The method described herein is advantageous in that the woven material has better edge retention during cutting and consequently experiences less undesirable distortion when plies are applied in the formation of a complex shape. In an embodiment, the composite ply displays better edge retention during cutting when compared with a similar ply that does not contain the polymer yarn.

The polymeric yarns may also be applied during the weaving process to help prevent tows from rotating or twisting distortion, for example if tows were spread during a process such as ribbonizing. In an embodiment, the composite ply experiences less undesirable distortion (rotating or twisting distortion) as compared with a similar ply that does not contain the polymer yarn, when both plies are subjected to equivalent deformation.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A composite ply comprising:
fill and warp tows in a woven ply; wherein the fill and warp tows comprise ceramic tows; or
bias and optional axial tows in a braided ply; wherein the bias and optional axial tows comprise ceramic tows; and
a polymer yarn;
wherein the polymer yarn is disposed in
a) the fill tows, warp tows, or both the fill and warp tows or
b) the bias tows, the optional axial tows, or both the bias and optional axial tows;
or wherein the polymer yarn is substituted for
a) a portion of fill tows, warp tows, or both the fill and warp tows; or
b) a portion of bias tows, optional axial tows or a combination of bias and optional axial tows;
or wherein the polymer yarn is disposed in the form of a ribbon or a net on
a) a portion of fill tows, warp tows, or both the fill and warp tows; or
b) a portion of bias tows, optional axial tows or a combination of bias and optional axial tows; and
wherein the polymer yarn bonds with the fill or warp tows or bonds with the bias or optional axial tows to prevent tow displacement in the composite ply.

2. The composite ply of claim 1, wherein the polymer yarn is woven into the fill tows, warp tows, or both the fill and warp tows after the fill and warp tows are first woven into a ply or wherein the polymer yarn is woven into the optional axial tows, bias tows, or both the optional axial and bias tows after the optional axial and bias tows are first braided into a braid.

3. The composite ply of claim 1, wherein the polymer yarn is heated above its glass transition temperature or is heated above its melting point to soften and bond it with the fill or warp tows or bond it with the bias or optional axial tows.

4. The composite ply of claim 1, wherein the polymer yarn is operative to bind adjacent plies with the composite ply in a lay-up.

5. The composite ply of claim 1, wherein the polymer yarn comprises a thermoplastic polymer, a thermosetting polymer, or a combination thereof.

6. The composite ply of claim 1, wherein the polymer yarn comprises a water-soluble polymer.

7. The composite ply of claim 1, wherein the water-soluble polymer is a polyvinylalcohol, a polyacrylamide, or a combination thereof.

8. The composite ply of claim 1, wherein the polymer yarn contacts at least two adjacent fill or warp tows in the composite ply.

9. The composite ply of claim 1, wherein the fill or warp tows comprise silicon carbide (SiC), alumina (Al₂O₃), mullite (Al₂O₃—SiO₂), or a combination thereof.

10. The composite ply of claim 1, wherein the composite ply is incorporated into a preform.

11. The composite ply of claim 10, wherein the preform is subjected to chemical vapor infiltration, polymer infiltration, melt infiltration, or a combination thereof with a ceramic matrix precursor to form a matrix material in the preform.

12. The composite ply of claim 11, wherein the matrix material comprises SiC, Al₂O₃, BN, B₄C, Si₃N₄, MoSi₂, SiO₂, SiOC, SiNC, and/or SiONC.

13. The composite ply of claim 1, wherein the fill tows or the warp tows that the polymer yarn is substituted for are periodically spaced or wherein the bias tows or optional axial tows that the polymer yarn is substituted for is periodically spaced.

14. The composite ply of claim 1, wherein the fill tows or the warp tows that the polymer yarn is substituted for are randomly spaced or wherein the bias tows or optional axial tows that the polymer yarn is substituted for are randomly spaced.

15. The composite ply of claim 1, wherein the composite ply displays better edge retention of tows during cutting over a similar ply that does not contain the polymer yarn.

16. The composite ply of claim 1, wherein the composite ply displays less rotating or twisting distortion of the fill and warp tows or the bias and optional axial tows as compared with a similar ply that does not contain the polymer yarn, when both plies are subjected to equivalent deformation.

17. The composite ply of claim 1, wherein all of the fill tows or all of the warp tows comprise the polymer yarn or wherein all of the optional axial or the bias tows comprise the polymer yarn.

18. An article manufactured from the composite ply of claim 1.

19. A method of manufacturing a composite ply comprising:
a) disposing a polymer yarn into a woven ply that comprises fill tows and warp tows to form the composite ply; or disposing a polymer yarn into a braided ply that comprises ceramic bias tows and optional axial tows to form the composite ply; or
b) substituting a polymer yarn for a portion of fill tows, warp tows, or both the fill and warp tows in a woven ply to form the composite ply; or substituting a portion of bias tows, optional axial tows or a combination of bias and optional axial tows in a braided ply to form the composite ply; or
c) disposing a polymer yarn in the form of a ribbon or a net on a portion of fill tows, warp tows, or both the fill and warp tows to form the composite ply; or
disposing a polymer yarn in the form of a ribbon or a net on a portion of bias tows, optional axial tows or a combination of bias and optional axial tows to form the composite ply; and
softening the polymer yarn to bond to the fill or warp tows or to bond to the bias tows and optional axial tows to prevent their displacement from the composite ply.

20. The method of claim 19, wherein the composite ply is formed into a preform; and wherein the preform is further subjected to a chemical vapor infiltration process, a polymer infiltration pyrolysis, melt infiltration, or a combination thereof, where a ceramic matrix precursor infiltrates the composite ply to form a matrix material.

21. The method of claim 19, wherein the polymer yarn comprises a water soluble polymer.

22. The method of claim 20, wherein the matrix material comprises SiC, Al₂O₃, BN, B₄C, Si₃N₄, MoSi₂, SiO₂, SiOC, SiNC, and/or SiONC.
